(19) United States
(12) Patent Application Publication
(10) Pub. No.: US 2025/0100154 A1
(43) Pub. Date: Mar. 27, 2025

(54) COMPUTER-IMPLEMENTED METHOD FOR CONTROLLING A ROBOT, ROBOT CONTROL METHOD, SYSTEM, ARTICLE MANUFACTURING METHOD, AND RECORDING MEDIUM

(71) Applicant: CANON KABUSHIKI KAISHA, Tokyo (JP)

(72) Inventors: HIROTO MIZOHANA, Tokyo (JP); RYOJI TSUKAMOTO, Kanagawa (JP); TOMOHIRO IZUMI, Kanagawa (JP)

(21) Appl. No.: 18/884,301

(22) Filed: Sep. 13, 2024

(30) Foreign Application Priority Data
Sep. 27, 2023 (JP) 2023-166526

(51) Int. Cl. B25J 9/16; B25J 13/08; G06T 7/73

(52) U.S. Cl. CPC B25J 9/1697; B25J 13/085; G06T 7/74; G06T 2207/20081

(57) ABSTRACT

A computer-implemented method for controlling a robot includes acquiring a current image showing a positional relationship between a first object held by the robot and a second object, determining whether the first object and the second object are in a reference positional relationship based on the current image, and controlling, in a case where a computer determines that the first object and the second object are in a reference positional relationship based on the current image, a position and a posture of the robot according to a trajectory of the robot set before the determining such that the first object and the second object have a target positional relationship.

### BACKGROUND OF THE INVENTION

### Field of the Invention

The present invention relates to a robot control method and the like.

### Description of the Related Art

Robots are being introduced in various fields including production sites. As one method for controlling a position and a posture of a robot, visual servoing in which a change in position of a target is measured as visual information, and the visual information is used as feedback information, is known.

JP 2015-74058 A discloses a robot control device that performs control by adding an output of visual servoing control based on visual information and an output of force control based on a force detection result at different ratios according to a distance from a target position.

JP 2013-180380 A discloses a control device in which a force control system is incorporated in a visual servoing system, and which controls a robot based on both load information applied to a target object and positional relationship between the target object and a component to be assembled.

For example, in a case of causing a robot hand to grip component 1 and perform work of assembling component 1 to component 2, when the robot is controlled by a control method according to a related art, the assembling work may not be performed correctly. Specifically, in a case where unintended deviation occurs in a relative position between component 1 and component 2 while the robot hand grips and moves component 1, the robot hand may not correctly assemble the components even when the robot hand is moved according to a taught trajectory.

Therefore, for the control of robots, there has been a demand for a technology that is advantageous in positioning two objects in an appropriate target positional relationship.

### SUMMARY OF THE INVENTION

According to a first aspect of the present invention, a computer-implemented method for controlling a robot includes acquiring a current image showing a positional relationship between a first object held by the robot and a second object, determining whether the first object and the second object are in a reference positional relationship based on the current image, and controlling, in a case where a computer determines that the first object and the second object are in a reference positional relationship based on the current image, a position and a posture of the robot according to a trajectory of the robot set before the determining such that the first object and the second object have a target positional relationship.

According to a second aspect of the present invention, a robot control method includes setting a position and a posture of a mechanical device such that a first teaching object held by the mechanical device and a second teaching object have a target positional relationship, changing the position and the posture of the mechanical device holding the first teaching object such that the first teaching object and the second teaching object that are in the target positional relationship have a reference positional relationship, acquiring a reference image showing that the first teaching object and the second teaching object are in the reference positional relationship, and controlling, by a computer, in a case where the computer acquires a current image showing a positional relationship between a first object held by a robot and a second object and determines that the first object and the second object are in the reference positional relationship based on the reference image and the current image, a position and a posture of the robot holding the first object such that the first object and the second object have the target positional relationship.

Further features of the present invention will become apparent from the following description of exemplary embodiments with reference to the attached drawings.

### BRIEF DESCRIPTION OF THE DRAWINGS

FIG. 1 is a schematic diagram for describing a configuration of a robot system according to a first embodiment.

FIG. 2 is a block diagram illustrating a configuration of a control system included in a robot according to the embodiment.

FIG. 3 is a schematic diagram illustrating a work environment of the robot.

FIG. 4A is a diagram illustrating a position and a posture of a first workpiece W1 gripped by a robot hand at an initial stage of assembling work.

FIG. 4B is a diagram illustrating a position and a posture of the first workpiece W1 gripped by the robot hand at an approach position.

FIG. 4C is a diagram illustrating a state in which work of assembling the first workpiece W1 to a second workpiece W2 is completed.

FIG. 5 is a flowchart illustrating a procedure of the assembling work according to the embodiment.

FIG. 6 is a diagram illustrating an example of image features used for extracting a target image IG and a target image feature amount F_{g} according to the embodiment.

FIG. 7A is a diagram illustrating a positional relationship between the first workpiece W1 and the second workpiece W2 before teaching.

FIG. 7B is a diagram illustrating a positional relationship (target positional relationship) between the first workpiece W1 and the second workpiece W2 when the work of assembling the first workpiece W1 to the second workpiece W2 is completed.

FIG. 7C is a diagram illustrating a positional relationship (reference positional relationship) between the first workpiece W1 and the second workpiece W2 when an operator manually pulls out the first workpiece W1 from the second workpiece W2.

FIG. 8 is a flowchart for describing a procedure for teaching an image feature amount as visual

feedback teaching data.

FIG. 9 is a diagram for describing an imaging area A1 of a visual sensor when acquiring a reference image.

### DESCRIPTION OF THE EMBODIMENTS

A robot control method and the like according to an embodiment of the present invention will be described with reference to the drawings. The embodiments described below are merely examples, and for example, detailed configurations can be appropriately changed and implemented by those skilled in the art without departing from the gist of the present invention. When describing control of an operation and a position and posture of a robot, contents of the description may include an operation of stopping the robot and control of maintaining the position and posture of the robot.

In the drawings referred to in the following description of the embodiments and examples, elements denoted by the same reference signs have the same functions unless otherwise specified. In the drawings, in a case where a plurality of the same elements is arranged, reference signs and a description thereof may be omitted.

In addition, the drawings may be schematic for convenience of illustration and description, and thus, the shape, size, arrangement, and the like of elements in the drawings may not strictly match those of actual ones.

### First Embodiment

As a first embodiment, a control method for causing a robot to perform work of assembling a first workpiece to a second workpiece will be exemplified. In the assembling work, the first workpiece is held by the robot to approach the second workpiece, and the first workpiece is moved to a position where the first workpiece and the second workpiece have a reference positional relationship, that is, an approach position. In the present specification, the “positional relationship” refers to a relative relationship including not only a position but also a posture. The approach position is set in advance as a positional relationship (reference positional relationship) in which the held first workpiece can be assembled to the second workpiece with high reliability by the robot. A robot operation of moving the first workpiece from the approach position to an assembly completion position is taught in advance to a control unit of the robot.

In the assembling work, the control unit acquires a current image obtained by imaging at least the first workpiece using an imaging unit, and determines whether or not the first workpiece and the second workpiece are in the reference positional relationship. In a case where it is determined that the first workpiece and the second workpiece are in the reference positional relationship, the control unit controls the position and posture of the robot according to a control program taught in advance, and moves the first workpiece to the assembly completion position (target positional relationship).

In order to make it possible to determine whether or not the first workpiece and the second workpiece are in the reference positional relationship, the control unit acquires in advance a target image (reference image) as visual feedback teaching data. The reference image is an image obtained by arranging a first teaching workpiece and a second teaching workpiece so as to have the reference positional relationship, and performing imaging using the imaging unit so as to include at least the first teaching workpiece. Except for manufacturing errors, the first teaching workpiece is substantially identical in shape to the first workpiece, and the second teaching workpiece is substantially identical in shape to the second workpiece. The first teaching workpiece may also be referred to as a first teaching object, and the second teaching workpiece may also be referred to as a second teaching object. That is, in the embodiment, the reference image showing that the first teaching object and the second teaching object are in the reference positional relationship is acquired in advance.

By comparing the current image with the reference image, the control unit can accurately determine whether or not the first workpiece is at the approach position, that is, whether or not the first workpiece and the second workpiece are in the reference positional relationship.

In the method according to the related art, whether or not a robot hand is in a predetermined position and posture for starting an approach operation during assembling work is determined using a position sensor of the robot hand or an image obtained by imaging the robot hand. Even in a case where it is determined that the robot hand is in the predetermined position and posture, the first workpiece is not in the predetermined position and posture with respect to the second workpiece when so-called gripping displacement occurs. The gripping displacement refers to a phenomenon in which the first workpiece is displaced with respect to the robot hand when or after the robot hand grips the first workpiece. When the assembling work is continued in a state in which the gripping displacement occurs, not only the assembling is not correctly performed, but also the workpieces may be damaged by collision or the like.

In the control according to the present embodiment, the control unit that controls the robot holding the first workpiece acquires the current image that enables determination of the positional relationship between the first workpiece and the second workpiece, and determines whether or not the first workpiece and the second workpiece are in the preset reference positional relationship based on the current image. The reference positional relationship is set in advance before the determination is performed, and for example, is set in advance before the current image is acquired. The reference positional relationship can be set when capturing the target image. When it is determined that the first workpiece and the second workpiece are in the reference positional relationship (approach position), the position and the posture of the robot are controlled such that the first workpiece and the second workpiece are in the target positional relationship (assembly completed state). As described above, in the present embodiment, it is confirmed from the image that the first workpiece and the second workpiece are in a positional relationship in which the robot can appropriately assemble the held first workpiece to the second workpiece at the position (that is, the reference positional relationship), and then the robot is caused to perform the final assembling operation. Therefore, there is no concern that the final assembling operation is continued unless it is confirmed that the first workpiece and the second workpiece are in the reference positional relationship in a case where so-called gripping displacement occurs. Even when the gripping displacement occurs, if it is confirmed that the first workpiece and the second workpiece are in the reference positional relationship, the final assembling operation can be performed by, for example, force control.

In the present embodiment, a robot control method for moving the first workpiece to the approach position is not particularly limited, and for example, the control unit may move the robot hand according to a taught trajectory, or a user may move the robot hand by using a pendant.

At least the first teaching workpiece is included in the target image (reference image). For example, both the first teaching workpiece and the second teaching workpiece having the reference positional relationship may be included in the reference image. The control unit can make determination by comparing the positional relationship between the first workpiece and the second workpiece shown in the current image with the positional relationship between the first teaching workpiece and the second teaching workpiece shown in the target image (reference image).

In a case where there is a position reference object (for example, a jig for fixing the second workpiece) having a fixed positional relationship with respect to the second workpiece, it is sufficient if the first teaching workpiece and the position reference object are included in the target image (reference image). The control unit can perform determination by comparing a positional relationship between the first workpiece and the position reference object shown in the current image and the positional relationship between the first teaching workpiece and the position reference object shown in the reference image.

A robot operation of moving the first workpiece confirmed to be in the reference positional relationship from the current image from the approach position to the assembly completion position is preferably performed by the force control. However, in a case where there is no problem even if the first workpiece is moved to the assembly completion position by position control, the robot operation may be performed by the position control. For example, a large clearance between the first workpiece and another object (including the second workpiece) is secured in a path along which the first workpiece is moved to the assembly completion position, and the first workpiece may be moved by the position control when a possibility of interference is extremely small. Alternatively, in a case where the first workpiece or the second workpiece is formed of a flexible material and there is no problem even if minor contact due to a control error occurs, the first workpiece may be moved by the position control. Furthermore, also in a case where a compliance mechanism such as a remote center compliance (RCC) device is provided in the robot, the first workpiece may be moved by the position control.

Hereinafter, a specific description will be given.

### Configuration of Robot System

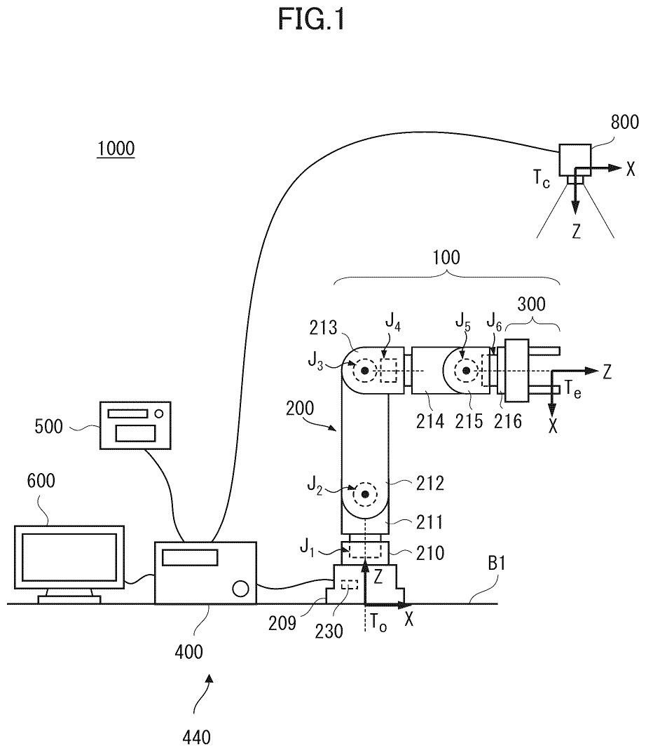

FIG. 1 is a schematic diagram for describing a configuration of a robot system 1000 according to the first embodiment. The robot system 1000 includes a robot 100, a servo control unit 230, a control device 400, an input device 500, a display 600, and a visual sensor 800. A control system 440 is configured around the control device 400.

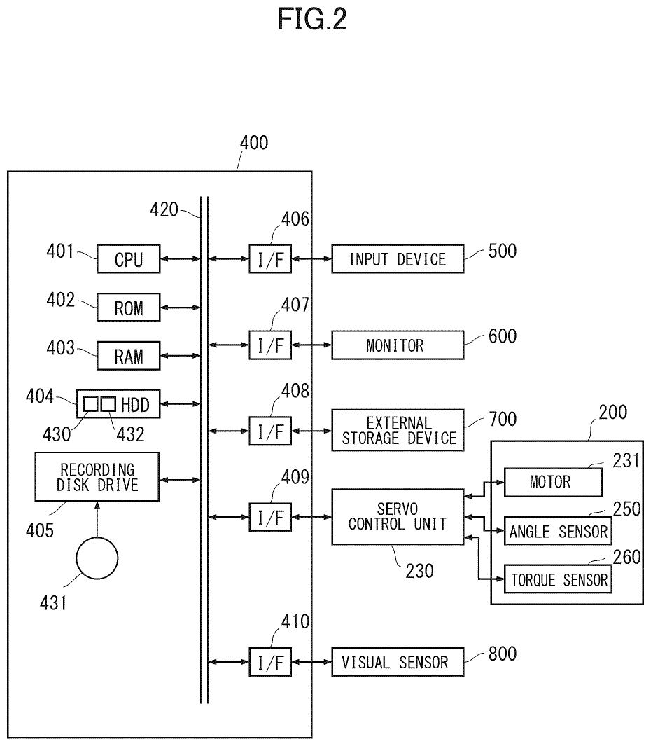

FIG. 2 is a block diagram illustrating a configuration of the control system 440 included in the robot system 1000 according to the embodiment. Each unit of the robot system 1000 will be described with reference to FIGS. 1 and 2.

### Control Unit

The control device 400 serving as the control unit is a computer that controls the entire robot system 1000 and performs various types of work such as the assembling work. The control device 400 includes a central processing unit (CPU) 401 serving as a processor.

The control device 400 includes, for example, a read only memory (ROM) 402, a random-access memory (RAM) 403, and a hard disk drive (HDD) 404 as a storage unit. In addition, the control device 400 includes a recording disk drive 405 and interfaces 406 to 410 serving as a plurality of input/output interfaces (I/Fs).

The ROM 402, the RAM 403, the HDD 404, the recording disk drive 405, and the interfaces 406 to 410 are connected to the CPU 401 via a bus 420. The ROM 402 stores a basic program such as a basic input/output system (BIOS). The RAM 403 is a storage device that temporarily stores various types of data such as an arithmetic processing result of the CPU 401.

The HDD 404 is a non-transitory computer-readable recording medium that stores a processing program executed by the CPU 401, an arithmetic processing result of the CPU 401, various types of data acquired from the outside, and the like. A program 430 for causing the CPU 401 to execute arithmetic processing and visual feedback teaching data 432 are recorded in the HDD 404. The CPU 401 executes each processing of an article manufacturing method based on the program 430 recorded (stored) in the HDD 404. Each processing can include an image processing method.

In the present embodiment, the program 430 and the visual feedback teaching data 432 are stored in the HIDD 404. However, the program 430 and the visual feedback teaching data 432 may also be stored in a recording medium other than the HIDD 404. That is, the program 430 and the visual feedback teaching data 432 may be recorded in any recording medium as long as the recording medium is a non-transitory computer-readable recording medium. For example, a flexible disk, a hard disk, an optical disk, a magneto-optical disk, a magnetic tape, or a non-volatile memory can be used. The optical disk is, for example, a disk medium such as a Blu-ray disk, a DVD, or a CD. The non-volatile memory is, for example, a storage device such as a USB memory, a memory card, a ROM, or an SSD. Various types of data, programs, and the like recorded in a recording disk 431 can be read by the recording disk drive 405.

The input device 500 is connected to the interface 406 of the control device 400. The CPU 401 acquires input data (input information) from the input device 500 via the interface 406 and the bus 420. The input device 500 is a device that can be operated by the user to input various types of information to the control device 400. For example, if a teaching pendant is used as the input device 500, an operator (user) can use the teaching pendant to teach a motion of a robot arm 200.

The display 600, which is an example of a display unit, is connected to the interface 407 of the control device 400. The display 600 can display various images output from the control device 400.

An external storage device 700 that is a storage unit such as a rewritable non-volatile memory or an external HDD can be connected to the interface 408 of the control device 400.

The servo control unit 230 of the robot 100 is connected to the interface 409 of the control device 400. The servo control unit 230 will be described below.

The visual sensor 800 serving as the imaging unit is connected to the interface 410 of the control device 400. The visual sensor 800 is an example of the imaging unit that captures an image and transmits the image to the control device 400, and is, for example, a digital camera. The visual sensor 800 is a two-dimensional camera, and can acquire two-dimensional image information by imaging a subject. The visual sensor 800 is not limited to a two-dimensional camera, and may be, for example, a three-dimensional camera. The visual sensor 800 performs imaging at predetermined time intervals (for example, every 30 ms) under the control of the CPU 401. As a result, the CPU 401 can acquire visual information, that is, data of a captured image, from the visual sensor 800 at predetermined time intervals (for example, every 30 ms).

In the present embodiment, the control system 440 includes the input device 500, the display 600, the visual sensor 800, the control device 400, and the servo control unit 230.

The CPU 401 of the control device 400 can acquire angle information from an angle sensor 250 of each joint via the servo control unit 230, the interface 409, and the bus 420. Similarly, the CPU 401 can acquire force sensing information from a force sensing sensor 260 of each joint. The force sensing sensor 260 may be a torque sensor that detects a torque that is one of the force sensing information, may be a force sensor that detects a force that is one of the force sensing information, or may be a sensor that detects both a torque and a force. The servo control unit 230 may divide an angle of a motor 231 detected using the angle sensor 250 by a reduction ratio of a speed reducer (not illustrated), convert the divided angle into angle information of a corresponding joint, and transmit the angle information to the CPU 401.

The CPU 401 of the control device 400 outputs data of a command value corresponding to each of joints J₁ to J₆ to the servo control unit 230 via the bus 420 and the interface 409 at a predetermined time interval (for example, 1 ms). The servo control unit 230 controls driving of the motor 231 of each joint based on the command value corresponding to each of the joints J₁ to J₆ acquired from the control device 400 such that an angle or torque of each of the joints J₁ to J₆ follows the command value. That is, the servo control unit 230 is configured to be able to perform the position control or the torque control on each joint of the robot 100.

### Robot

The robot 100 (FIG. 1) is, for example, an industrial robot, and includes the robot arm 200 and a robot hand 300. In the present embodiment, the robot 100 including the vertically articulated robot arm 200 is exemplified, but the robot is not limited thereto. Any robot may be used as long as the robot includes a mechanism that is controlled by a control device and can automatically perform, for example, operations of expansion and contraction, bending and stretching, vertical movement, horizontal movement, or turning, or a combined operation thereof.

The robot 100 is installed in a manufacturing line, for example, and is used to perform various works for manufacturing an article. Examples of the work for manufacturing an article can include conveyance work, assembling work, processing work, or coating work. Examples of the processing work can include cutting work, grinding work, polishing work, or sealing work.

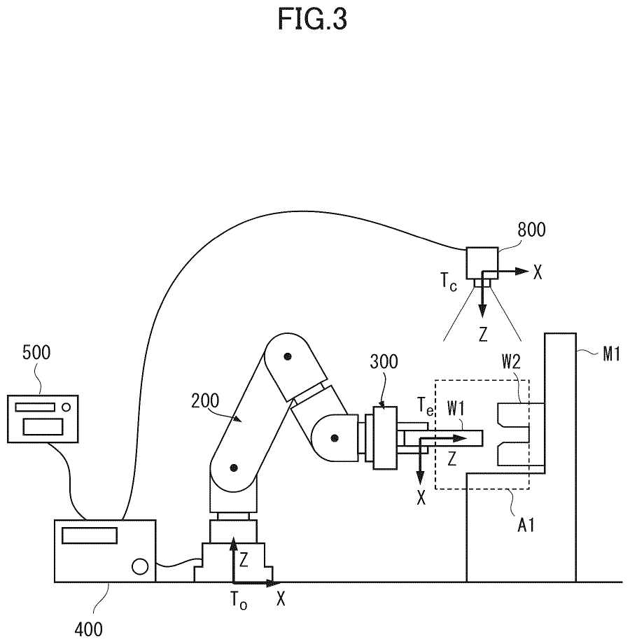

An end effector corresponding to a work content is attached to the robot arm 200. A link 216 positioned at a distal end portion of the robot arm 200 is a support portion configured to mount and support the end effector. In the present embodiment, a case where the robot hand 300 is mounted on the robot arm 200 as the end effector is taken as an example, and a control method in the assembling work will be described. As described below with reference to FIG. 3, in an example of the assembling work, the first workpiece W1 is held by the robot hand 300, and the robot arm 200 is operated to assemble the first workpiece W1 to the second workpiece W2.

The robot arm 200 includes a base 209, links 210 to 216, and the joints J₁ to J₆. The base 209, which is a base end (fixed end), is installed on an upper surface of a pedestal B1. The links 210 to 216 are connected in series via the joints J₁ to J₆ in this order. Each of the joints J₁ to J₆ includes the motor 231, the angle sensor 250, and the force sensing sensor 260. For convenience of illustration, FIG. 2 illustrates only a configuration of one joint as a component of the robot arm 200. The link 210 which is a base end portion of the robot arm 200 is fixed to the base 209. Each of the links 211 to 216 is rotationally driven by the joints J₁ to J₆ connecting the links 211 to 216. As a result, the robot arm 200 can adjust a position and a posture of the robot hand 300 to an arbitrary position in a three-axis direction and an arbitrary posture in the three-axis direction.

The position and posture of the robot arm 200 can be expressed by a coordinate system. A coordinate system Tₒ in FIG. 1 is a coordinate system set on the pedestal B1 to which the robot arm 200 is fixed. A coordinate system Tₑ is a coordinate system set on the robot hand 300. The coordinate system Tₑ represents a tool center position (TCP). For example, the coordinate system Tₑ is set on the robot hand 300. The coordinate system Tₒ and the coordinate system Tₑ are represented by orthogonal coordinates of three axes including XYZ axes.

A coordinate system T_{c} is a coordinate system set at the center of the visual sensor 800, and is represented by orthogonal coordinates of three axes including XYZ axes similarly to the coordinate system Tₑ and the coordinate system Tₑ, and is set such that an optical axis direction of the visual sensor 800 is a Z-axis direction. In the present embodiment, a case where the visual sensor 800 is fixed to a predetermined position based on the coordinate system Tₒ, for example, the pedestal B1, is described. However, the visual sensor 800 may be fixed to the robot arm 200 or the robot hand 300.

The servo control unit 230 controls driving of the motor 231 included in each of the joints J₁ to J₆. The servo control unit 230 is electrically connected to the motor 231, the angle sensor 250, and the force sensing sensor 260 included in each of the joints J₁ to J₆. The motor 231 is, for example, a brushless DC motor or AC motor, and rotationally drives the joint via the speed reducer (not illustrated). The angle sensor 250 is, for example, a rotary encoder, is attached to the motor 231, and is configured to be able to detect a rotation angle of the motor 231. The force sensing sensor 260 is configured to be able to detect a torque applied to the joint.

The servo control unit 230 is disposed inside the base 209, for example, and may also be disposed at another position. For example, the servo control unit 230 may be disposed inside a casing of the control device 400. That is, the servo control unit 230 may be a part of the configuration of the control device 400.

### Work

Next, work performed by the robot 100 in the present embodiment will be described. FIG. 3 is a schematic diagram illustrating a work environment of the robot 100. In the present embodiment, a control method will be described by exemplifying work of assembling the first workpiece W1 gripped by the robot hand 300 to the second workpiece W2 fixed to a workpiece fixing jig M1.

In FIG. 3, an imaging range imaged by the visual sensor 800 is illustrated as an imaging area A1 surrounded by a broken line. The imaging area A1 is set such that at least the first workpiece W1 gripped by the robot hand 300 is included in an angle of view when the robot 100 is at the approach position, and specifically, can be set in some modes.

For example, the imaging area A1 can be set such that both the first workpiece W1 gripped by the robot hand 300 at the approach position and the second workpiece W2 fixed to the workpiece fixing jig M1 are included in the angle of view. With this setting, it is possible to extract the first workpiece W1 and the second workpiece W2 from the captured image by image processing and calculate the relative positional relationship between the first workpiece W1 and the second workpiece W2.

In a case where a positional relationship between the second workpiece W2 and the workpiece fixing jig M1 is known in advance, the imaging area A1 can be set such that both the first workpiece W1 gripped by the robot hand 300 at the approach position and the workpiece fixing jig M1 are included in the angle of view. With this setting, the relative positional relationship between the first workpiece W1 and the second workpiece W2 can be calculated by extracting the first workpiece W1 and the workpiece fixing jig M1 from the captured image by image processing and obtaining a relative positional relationship between the first workpiece W1 and the workpiece fixing jig M1.

In addition, the imaging area A1 can be set such that both the first workpiece W1 and the second workpiece W2 are included in the angle of view not only at a time point when the robot hand 300 is at the approach position but also from the start of the assembling work. Such setting is suitable for moving the first workpiece W1 to the approach position by visual servoing.

Since the visual sensor 800 only needs to be able to acquire an image for determining the positional relationship between the first workpiece W1 and the second workpiece W2, the visual sensor 800 does not necessarily have to be installed at the position illustrated in FIG. 3. The visual sensor 800 may be disposed to move according to a change in position and posture of the robot. For example, the visual sensor 800 may be installed on a link on a distal end side of the robot arm or the robot hand 300. In a case where the visual sensor 800 is used as such an on-hand camera, the first workpiece W1 held by the robot hand 300 moves together with the visual sensor 800, and thus, the first workpiece W1 can be immovable in a field of view of the visual sensor 800. In a case where the visual sensor 800 is used as a global camera, the visual sensor 800 is fixed at an installation location of the robot arm, and the robot hand 300 and the first workpiece W1 move with respect to the visual sensor 800, and thus, the first workpiece W1 can be movable in the field of view of the visual sensor 800. In order to more accurately determine the positional relationship between the first workpiece W1 and the second workpiece W2, the on-hand camera is more suitable than the global camera.

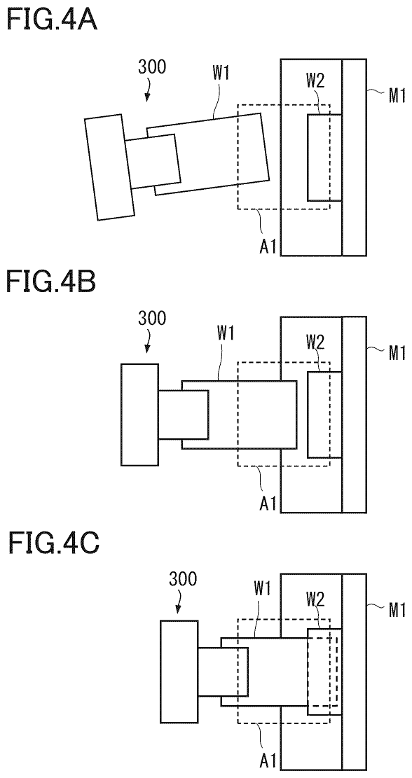

FIGS. 4A to 4C are schematic diagrams for specifically describing the assembling work exemplified in the present embodiment. FIG. 4A illustrates a position and a posture of the first workpiece W1 gripped by the robot hand 300 at an initial stage of the assembling work. FIG. 4B illustrates a position and a posture of the first workpiece W1 gripped by the robot hand 300 at the approach position. In this example, the approach position is set as a position where the assembling work with respect to the second workpiece W2 is completed by translationally moving the first workpiece W1 by a predetermined distance. The positional relationship between the first workpiece W1 and the second workpiece W2 when the first workpiece W1 is at the approach position can be referred to as the reference positional relationship. FIG. 4C illustrates a state in which the work of assembling the first workpiece W1 to the second workpiece W2 is completed. The positional relationship between the first workpiece W1 and the second workpiece W2 in a state in which the assembling work is completed can be referred to as the target positional relationship. Normally, the first workpiece W1 and the second workpiece W2 are separated from each other in the reference positional relationship, and the first workpiece W1 and the second workpiece W2 are in contact with each other in the target positional relationship.

In the present embodiment, the control device 400 controls the robot arm using visual feedback to move the robot arm 200 to the approach position, and determines whether or not the first workpiece W1 and the second workpiece W2 are in the positional relationship illustrated in FIG. 4B using an image captured by the visual sensor 800. Here, the visual feedback is a method of performing control by feeding back for a position command value for the robot arm 200 such that an image feature amount acquired by the visual sensor 800 becomes a desired value. In the embodiment, a case of using the so-called visual servoing that causes the image feature amount to gradually follow a desired value is described, but the present technology is not limited thereto. For example, an approach trajectory may be generated in advance based on the visual information of the visual sensor 800 without gradual following, and the robot arm 200 may be driven along the trajectory. In a case where it is determined that the first workpiece W1 and the second workpiece W2 have the positional relationship illustrated in FIG. 4B, the control device 400 transmits, to the servo control unit 230, an operation command to translationally move the robot hand 300 by a predetermined distance by the force control according to a control program taught in advance.

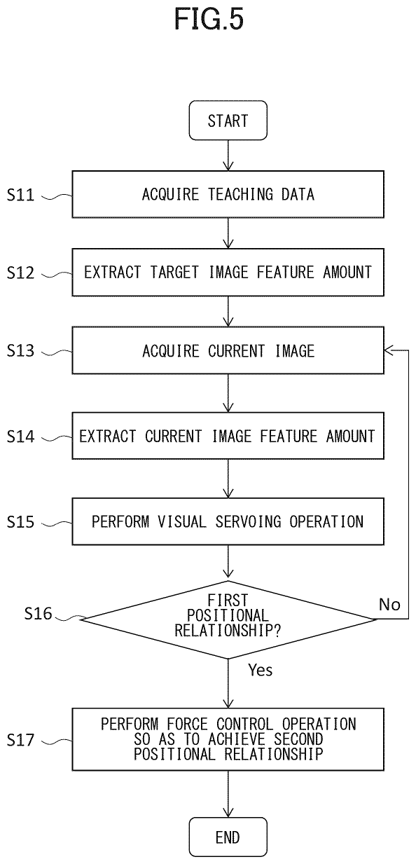

FIG. 5 is a flowchart illustrating a procedure of the assembling work according to the embodiment. The CPU 401 executes the processing according to the flowchart illustrated in FIG. 5 by executing the program 430.

In step S11, the CPU 401 acquires the visual feedback teaching data 432 recorded in the HDD 404. Here, the visual feedback teaching data 432 is, for example, a target image IG (reference image) captured by the visual sensor 800 when the first workpiece W1 and the second workpiece W2 are in the state illustrated in FIG. 4B. The target image IG is temporarily copied to, for example, the RAM 403. The target image IG may be captured using the first workpiece W1 and the second workpiece W2 used later in the actual assembling work. However, if it can be recognized that the two objects are in the target positional relationship, an object other than the first workpiece W1 and the second workpiece W2 used in the actual assembling work can be used as a teaching object. For example, the target image IG may be captured using the first teaching workpiece and the second teaching workpiece that are substantially similar or identical in shape to the first workpiece W1 and the second workpiece W2. Similarly, as a teaching robot arm used at the time of teaching, a mechanical device other than the robot arm used in the actual assembling work can be used. As the teaching robot arm, a mechanical device of the same type as the working robot arm can be used. However, in consideration of an individual difference of the robot arm and the like, it is desirable to perform teaching or acquire the target image IG by using the robot arm used in the actual assembling work.

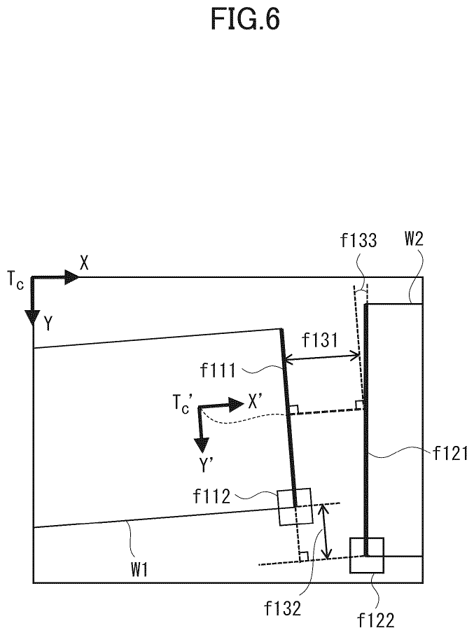

In step S12, the CPU 401 extracts a target image feature amount F_{g} from the visual feedback teaching data 432. FIG. 6 illustrates an example of image features used for extracting the target image IG and the target image feature amount F_{g} according to the embodiment. The CPU 401 extracts an edge f111 of the first workpiece W1 closest to the second workpiece W2, an edge f121 of the second workpiece W2 closest to the first workpiece W1, a predetermined portion f112 of the first workpiece W1, and a predetermined portion f122 of the second workpiece W2 from the target image IG. The predetermined portions are, for example, an end point of the edge f111 of the first workpiece W1 and an end point of the edge f121 of the second workpiece W2. A known method can be used as a method for extracting the edge f111, the edge f121, the portion f112, and the portion f122. For example, a line segment detection method using Hough transform can be used to extract the edge f111 and the edge f121. The portion f112 and the portion f122 may be extracted based on extraction results of the edge f111 and the edge f121.

More preferably, the extraction of the edge f111 and the edge f121 and the extraction of the portion f112 and the portion f122 are desirably performed by different methods. For example, a line segment detection method using Hough transform can be used to extract the edge f111 and the edge f121, and template matching can be used to extract the portion f112 and the portion f122. In this case, even when an erroneous image feature is extracted due to a failure of the image processing, the error can be detected by comparing the extraction results of the edge f111 and the portion f112 or the extraction results of the edge f121 and the portion f122. In a case where the template matching is used to extract the portion f112 and the portion f122, in step S12, input values input by the operator or values recorded in the HDD 404 or the like are registered as positions and sizes of the portion f112 and the portion f122. Then, the corresponding range of the target image IG may be registered as a template. The registered template is temporarily recorded in the RAM 403 or the like. A coordinate system T_{c}′ is a coordinate system on the target image IG in which a perpendicular bisector of the edge f111 is an X′ axis and a direction along the edge f111 is a Y′ axis on the target image IG. The target image feature amount F_{g} is calculated by coordinates on the coordinate system T_{c}′. For example, the target image feature amount F_{g} includes three values of a distance f131 between an intersection of the edge f111 and the X′ axis and an intersection of the edge f121 and the X′ axis, a difference f132 between positions of the predetermined portion f112 and the predetermined portion f122 in a Y′-axis direction, and an angle f133 formed by the edge f111 and the edge f121. That is, the target image feature amount F_{g} is represented by F_{g}=[f131 f132 f133]^{T} as a three-dimensional vector including the distance f131, the difference f132, and the angle f133. The subscript T represents transposition of a vector or a matrix.

Next, when the actual assembling work is started, in step S13, the CPU 401 causes the visual sensor 800 to perform imaging to acquire a current image IC. The current image IC is temporarily recorded in the RAM 403 or the like, for example.

In step S14, the CPU 401 extracts a current image feature amount F_{c} from the current image IC by a method similar to the method for extracting the target image feature amount F_{g} from the target image IG in step S12. Hereinafter, the respective components of the target image feature amount F_{g} are denoted as fg131, fg132, and fg133, and the respective components of the current image feature amount F_{c} are denoted as fc131, fc132, and fc133. That is, F_{g}=[fg131 fg132 fg133]^{T} and F_{c}=[fc131 fc132 fc133]^{T}. At this time, the extracted current image feature amount F_{c} may be displayed on the display 600.

In step S15, the CPU 401 calculates a control amount qᵥ of each of the joints J₁ to J₆ of the robot from the target image feature amount F_{g} and the current image feature amount F_{c}, and operates the robot. In calculating the control amount qᵥ, first, a feature amount difference Fₑ (F is in bold) between the current image feature amount F_{c} and the target image feature amount F_{g} is calculated according to the following Equation (1).

$${F}_{e} = [ \begin{matrix}fc 131 - fg 131 \\ fc 132 - fg 132 \\ fc 133 - fg 133\end{matrix} ] \qquad ( 1 )$$

Subsequently, the CPU 401 calculates a matrix of an image Jacobian J_{img} (J is in bold) and a matrix of a robot Jacobian Jᵣ(J is in bold). The image Jacobian J_{img} is a matrix of three rows and three columns associating minute displacement amounts of the coordinate system Tₑ set on the robot hand 300 with minute displacement amounts of the current image feature amount F_{c}. The robot Jacobian Jᵣ is a matrix of three rows and six columns associating minute displacement amounts of the joints J₁ to J₆ of the robot arm 200 with minute displacement amounts of the coordinate system Tₑ set on the robot hand 300. The image Jacobian J_{img} and the robot Jacobian Jᵣ are defined according to the following Equation (2).

$${J}_{img} = \frac{\partial {F}_{c}}{\partial {x}_{e}^{T}} , {J}_{r} = \frac{\partial {x}_{e}}{\partial {q}^{T}} \qquad ( 2 )$$

Here, xₑ (x is in bold) is a position vector xₑ=[Xₑ Yₑ αₑ]^{T} of three degrees of freedom of the coordinate system Tₑ in the coordinate system Tₒ, and αₑ is a rotation angle around a Z axis of the coordinate system Tₒ. q (q is in bold) represents a joint angle vector q=[q₁ . . . q₆]^{T} of each of the joints J₁ to J₆ of the robot arm 200.

Subsequently, the CPU 401 calculates the control amount qᵥ (q is in bold) of each of the joints J₁ to J₆ of the robot. The control amount qᵥ is calculated, for example, according to the following Equation (3).

$${q}_{v} = - {J}_{r}^{+} λ {J}_{img}^{- 1} {F}_{e} \qquad ( 3 )$$

λ (λ is in bold) in Equation (3) is a feedback gain represented by a three-dimensional vector, the subscript-1 represents an inverse matrix, and + represents a pseudo inverse matrix. A method for calculating the control amount qᵥ from the feature amount difference Fₑ is not limited to the above-described method, and other known methods may be freely used. The CPU 401 calculates a new angle command value by adding the control amount qv to the previous angle command value of each of the joints J₁ to J₆ of the robot. Then, the CPU 401 performs a visual feedback operation by operating the robot arm 200 via the servo control unit 230 based on the angle command value.

In step S16, the CPU 401 determines whether or not a position correction operation by the visual feedback has been completed and the reference positional relationship has been achieved. If the feature amount difference Fe is equal to or smaller than a predetermined value, it is determined that the reference positional relationship has been achieved, and the processing proceeds to step S17. If the feature amount difference Fₑ is larger than the predetermined value, the processing returns to step S13, and the visual feedback operation is performed again. Here, the predetermined value is a value that can be determined with sufficient accuracy to appropriately perform the subsequent assembling work in the force control, and the same value may be used for all the values included in the feature amount difference Fₑ. Alternatively, the determination may be made using different values, and the correction operation may be continued until all the values satisfy the condition.

In step S17, the CPU 401 operates the robot arm 200 by using the force control, causes the first workpiece W1 to follow the second workpiece W2, and performs the assembling operation so as to achieve the target positional relationship. In the control device 400, a motion amount of the robot hand 300 for transitioning from the state of FIG. 4B to the state of FIG. 4C and a motion amount of the robot hand 300 with respect to a hand tip reaction force are set in advance by teaching. Here, the hand tip reaction force is an external force generated in the robot hand 300 by contact between the first workpiece W1 and the second workpiece W2, and is acquired by converting a detection value of the force sensing sensor 260 of each joint into that for a hand tip. The CPU 401 operates the robot arm 200 until the hand tip reaction force becomes a taught value, the motion amount of the robot hand 300 becomes the taught value, or both the hand tip reaction force and the motion amount of the robot hand 300 become the taught values. The operation to be performed by the robot arm 200 in step S17 is not limited to the operation set in advance before step S16 is performed, that is, the operation set by the previously-performed teaching, and may be an operation instructed by the user after the current image is acquired in step S13, or an operation according to a trajectory instructed by the user after the current image is acquired. The motion and the trajectory instructed by the user after the current image is acquired in step S13 can be set by the user (operator) manually operating (so-called jog operation) the robot arm 200 via the input device 500.

The force control method includes hybrid control in which a position and a force are completely separated and individually controlled, and impedance control in which a position and a force are controlled in a linear relationship. The impedance control is a method in which mechanical impedance characteristics of the hand tip of the robot are set to appropriate values in advance, and a force applied to a target object by the hand tip is indirectly controlled through adjustment of a hand tip target position. The hybrid control is a method in which a position control direction of the hand tip and a force control direction are clearly distinguished, and a force control rule is used for the force control direction. In the impedance control, both an elastic term and a viscous term can be considered in calculation of a target value, and only the elastic term can be used while ignoring the viscous term, and in this case, the impedance control can be referred to as compliance control. The compliance control is treated as a type of impedance control. In the present embodiment, the force control may be either hybrid control or impedance control, but it is preferable to use the impedance control for an operation from the reference positional relationship to the target positional relationship. In step S17, a case where the first workpiece W1 is caused to follow the second workpiece W2 by the force control and the assembling operation is performed has been described, but the assembling operation may be performed by the position control depending on the situation. For example, in a case where a gap between the workpieces at the time of assembly is sufficiently large, in a case where the material is soft, or in a case where the compliance mechanism is provided in the robot, the workpieces can be assembled by the position control. In step S17, the position and the posture of the first workpiece W1 may be maintained, and the second workpiece W2 may be moved to follow the first workpiece W1 such that the first workpiece W1 and the second workpiece W2 have the target positional relationship.

As described above, according to the present embodiment, the visual feedback control is performed using the distance f131, the difference f132, and the angle f133 which are the image features determined by the positional relationship between the first workpiece W1 and the second workpiece W2. According to the present embodiment, even when the first workpiece W1 and the robot hand 300 are misaligned due to the gripping displacement or the like, whether or not the first workpiece W1 and the second workpiece W2 are in the predetermined reference positional relationship is confirmed by using an image, and whether or not the final operation can be performed is determined.

Further, if the approach position is set to a position immediately before the first workpiece W1 and the second workpiece W2 come into contact with each other, and switching from the visual feedback control to the force control is made at the approach position, it is possible to prevent the visual feedback control from becoming unstable due to occlusion or the like. In addition, by minimizing a movement amount of the robot hand 300 in the force control, the assembling operation can be completed without deteriorating the accuracy, and work performance of the robot can be improved.

### Second Embodiment

As a second embodiment, a modified example of a control method for causing a robot to perform work of assembling a first workpiece to a second workpiece will be described. A description of matters common to the first embodiment will be simplified or omitted. The present embodiment is characterized by a method for setting an approach position and a method for acquiring a reference image (and an image feature amount) serving as visual feedback teaching data.

As described above, when determining that a first workpiece W1 and a second workpiece W2 are in a preset reference positional relationship (that is, the first workpiece W1 is at a predetermined approach position), a control unit can cause the robot to perform the final movement operation in an assembling operation. In order to perform precise assembly, it is necessary to appropriately set the approach position so that the first workpiece W1 easily enters an inlet of the second workpiece W2 in the final movement operation. In the present embodiment, a reference image is captured by setting the approach position by a method described below, and a control device 400 acquires the visual feedback teaching data. That is, the processes illustrated as step S11 and step S12 in the flowchart of FIG. 5 of the first embodiment are performed in a procedure described below in the present embodiment.

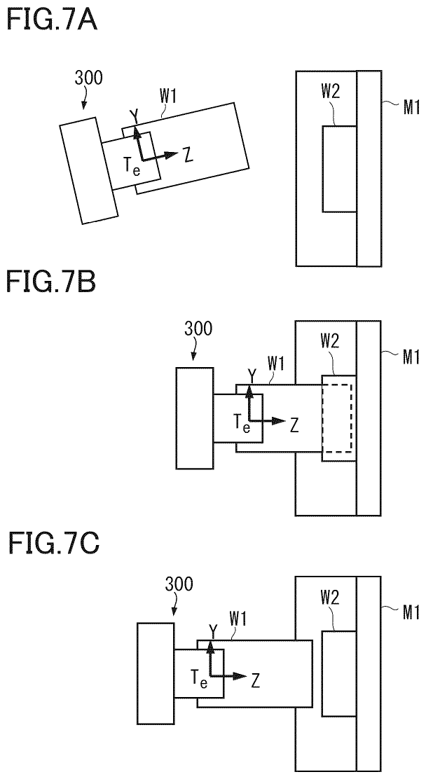

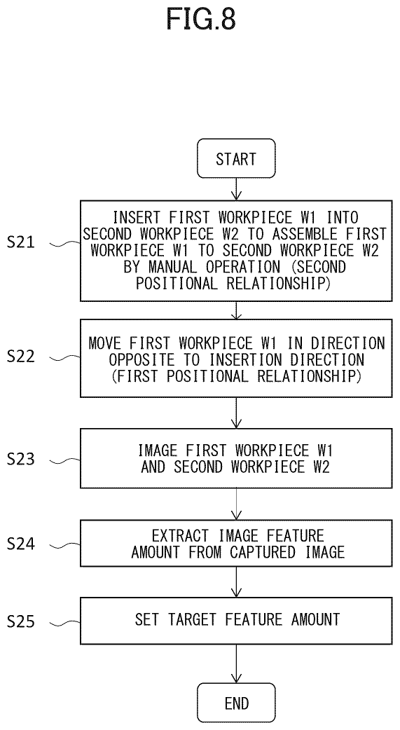

FIGS. 7A to 7C are explanatory diagrams for describing a procedure of acquiring the visual feedback teaching data in the present embodiment, and FIG. 8 is a flowchart for describing a procedure of teaching the image feature amount as the visual feedback teaching data.

FIG. 7A illustrates a positional relationship between the first workpiece W1 and the second workpiece W2 before teaching. A robot hand 300 grips the first workpiece W1, but the first workpiece W1 is positioned away from the second workpiece W2.

In step S21, an operator manually operates (so-called jog operation) a robot arm 200 via an input device 500 to move the first workpiece W1 from the position illustrated in FIG. 7A, assemble the first workpiece W1 to the second workpiece W2, and complete the assembly. That is, the first workpiece W1 and the second workpiece W2 are in a target positional relationship. FIG. 7B is a diagram illustrating a positional relationship (target positional relationship) between the first workpiece W1 and the second workpiece W2 when the operator completes the work of assembling the first workpiece W1 to the second workpiece W2 by manual operation. The manual operation of the robot arm 200 is an operation of moving the robot arm 200 in each of an X-axis translation movement direction, a Y-axis translation movement direction, a Z-axis translation movement direction, an X-axis rotation direction, a Y-axis rotation direction, and a Z-axis rotation direction of a coordinate system Tₑ set on the robot hand 300. The operator adjusts a position or a rotation angle in the above directions with the input device 500 to assemble the first workpiece W1 to the second workpiece W2.

Next, in step S22, the operator manually operates the robot arm 200 to offset the first workpiece W1 in a direction opposite to an assembling direction in the previous step, and pulls out the first workpiece W1 from the second workpiece W2. That is, the first workpiece W1 is linearly moved in a negative direction of a Z axis of the coordinate system Tₑ to be pulled out from the second workpiece W2. FIG. 7C is a diagram illustrating a positional relationship (reference positional relationship) between the first workpiece W1 and the second workpiece W2 when the operator manually pulls out the first workpiece W1 from the second workpiece W2. The first workpiece W1 and the second workpiece W2 at this time are in a positional relationship in which the workpieces can be assembled by linearly moving the first workpiece W1 in a Z-axis direction of the coordinate system Tₑ. That is, if the assembling operation is performed by the force control described above with the position of the first workpiece W1 illustrated in FIG. 7C as the approach position, the assembly can be appropriately performed. Also in the present embodiment, the force control may be either hybrid control or impedance control, but it is preferable to use the impedance control for an operation from the reference positional relationship to the target positional relationship.

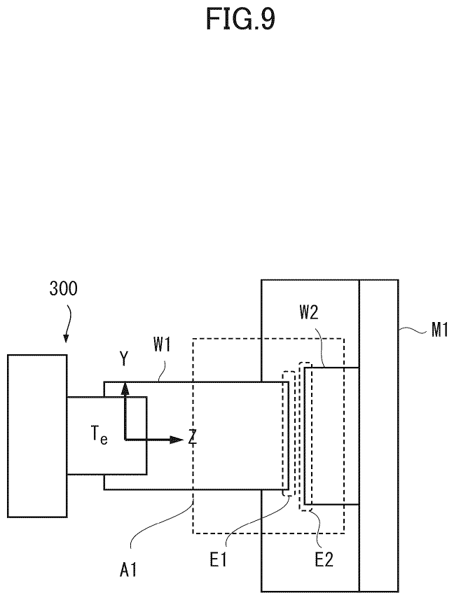

FIG. 9 is a diagram for describing an imaging area A1 of a visual sensor 800 when acquiring the reference image serving as the visual feedback teaching data. In FIG. 9, the imaging area A1 indicated by a broken line represents a field-of-view area of the visual sensor 800, E1 is an end portion of the first workpiece W1 on a distal end side, and E2 is an end portion of the second workpiece W2 on an opening portion side. In step S22, an offset amount when the first workpiece W1 is pulled out from the second workpiece W2 is set to a range in which the end portion E1 of the first workpiece W1 on the distal end side and the end portion E2 of the second workpiece W2 on the opening portion side are within the imaging area A1. As long as the first workpiece W1 and the second workpiece W2 are in the imaging area A1, the imaging area A1 may change depending on a position, posture, angle of view, and the like of the visual sensor 800. At this time, for example, it is sufficient if the same imaging area A1 is used when capturing a target image IG (reference image) and a current image IC, or visual information is corrected by a known optical geometric correction method or the like based on internal and external parameters of the visual sensor 800.

In step S23, the operator inputs an acquisition command for the target image IG to the control device 400. The control device 400 receives the acquisition command input for the target image IG and sends an imaging command to the visual sensor 800 via an interface 410 and a bus 420. The control device 400 acquires a captured image of the imaging area A1 from the visual sensor 800, and temporarily stores the captured image in a RAM 403 as the target image IG (reference image). The target image IG is image data (visual information) obtained by imaging the first workpiece W1 at the approach position illustrated in FIG. 9. That is, the target image IG includes the visual information of the end portion E1 of the first workpiece W1 on the distal end side and the end portion E2 of the second workpiece W2 on the opening portion side in the reference positional relationship before the start of assembly.

In step S24, the control device 400 extracts an image feature amount between the end portion E1 of the first workpiece W1 on the distal end side and the end portion E2 of the second workpiece W2 on the opening portion side from the target image IG acquired in step S23. A method for extracting the image feature amount is similar to the method described above, and a description thereof will be omitted here.

Finally, in step S25, the control device 400 temporarily stores the image feature amount extracted in step S24 in the RAM 403 as a target image feature amount F_{g}. The target image feature amount F_{g} is a feature amount extracted from an image captured in a state in which the first workpiece W1 and the second workpiece W2 have a predetermined assembly start positional relationship (reference positional relationship) in step S23. That is, a robot 100 can move the first workpiece W1 to an accurate assembly start position (approach position) by performing the visual feedback operation described above with respect to the target image feature amount F_{g}. If it is confirmed that there is no problem when actual assembling work is performed using the temporarily stored target image feature amount F_{g}, the control device 400 can store the target image feature amount F_{g} in an HDD 404 and reuse the target image feature amount F_{g} according to an instruction of the operator.

As described above, with the assembly start position teaching method according to the embodiment described above, it is possible to easily acquire the target image IG and the target image feature amount F_{g} at the accurate assembly start position by performing offsetting based on a position where the assembly has been completed once.

Although a case where the operator performs the jog operation on the robot arm 200 via the input device 500 to assemble the first workpiece W1 to the second workpiece W2 has been described in step S21, the assembly may also be performed by direct teaching in which the operator directly touches and operates the robot. The direct teaching is a teaching method in which the robot arm 200 is made flexible with respect to an external force by the impedance control or the like to follow a reaction force from the operator or the workpiece. That is, not only the operation of the robot arm 200 becomes intuitive, but also a load on the workpiece until reaching a workpiece assembling completion position illustrated in FIG. 7B can be reduced, and deviation of the workpiece can be eliminated, so that a more accurate position can be taught.

The control device 400 can acquire an execution program for the final operation performed in step S17 (FIG. 5) at the time of the assembling work by executing reverse reproduction processing for a movement operation from FIG. 7B to FIG. 7C performed according to the instruction of the operator in step S22. That is, the position and posture of the robot arm can be changed during the assembling work based on transition of the position and posture of the robot arm when the movement operation (a change in position and posture of the robot arm) is performed. More specifically, a motion (the amount of change in position and posture) in the coordinate system Tₑ during the movement operation in step S22 is stored in time series, and the time-series motion data is inverted on a time axis. A position in the coordinate system Tₑ is stored as coordinates calculated from an encoder value of each joint, and a change (displacement) in coordinates is stored as the transition of the position and posture of the robot arm. Then, at the time of the assembling work in step S17, the robot arm 200 is operated using the inverted motion data as a target trajectory of the coordinate system Tₑ. As a result, not only linear movement assembly but also more complicated assembly such as assembling the workpiece W1 to the workpiece W2 while rotating the workpiece W1 can be performed. The motion data may be subjected to smoothing, thinning processing, and the like within a range not affecting the assembling work by analyzing the magnitude of noise, the density of position and posture in time series, and the like as necessary. The operation to be performed by the robot arm 200 in step S17 is not limited to an operation set in advance before step S16 is performed like the operation based on the transition of the position and posture of the robot arm in step S22. The operation to be performed by the robot arm 200 in step S17 may be an operation instructed by the user after the current image is acquired in step S13.

In addition, although a case where steps S22 and S23 are performed by the operator performing an input operation on the control device 400 has been described, the execution method is not limited thereto. For example, if design information such as the angle of view of the visual sensor 800, dimensions of the first workpiece W1 and the second workpiece W2, or the assembling direction is known in advance, a direction in which the first workpiece W1 is pulled out and the offset amount can also be determined in advance. That is, steps S22 to S25 may be programmed in advance, and after step S21, a series of teaching work may be automatically performed by execution of a program.

In the embodiment described above, a case where both the first workpiece W1 and the second workpiece W2 are included in the target image IG has been described, but the first workpiece W1 and the second workpiece W2 do not always have to be included in the target image IG. For example, in a case where a positional relationship of one workpiece with respect to the visual sensor 800 is known in advance or in a case where the change can be ignored, it is sufficient if one of the first workpiece W1 and the second workpiece W2 is included in the target image IG. Alternatively, in a case where there is a position reference object (for example, a jig for fixing the second workpiece W2) having a fixed positional relationship with respect to the second workpiece W2, it is sufficient if the first workpiece W1 and the position reference object are included in the target image. The control unit can perform determination by comparing a positional relationship between the first workpiece and the position reference object shown in the current image and the positional relationship between the first teaching workpiece and the position reference object shown in the target image.

Also in the present embodiment, in the assembling work, the control unit acquires the current image obtained by imaging at least the first workpiece using an imaging unit, and determines whether or not the first workpiece and the second workpiece are in the reference positional relationship. In a case where it is determined that the reference positional relationship is achieved, that is, in a case where it is determined that the first workpiece is at the approach position, the control unit controls the position and posture of the robot according to a control program taught in advance, and moves the first workpiece to the assembly completion position (target positional relationship).

In the present embodiment, when the approach position is set and the target image is captured in advance, after the assembly of the first workpiece and the second workpiece is once completed and the target positional relationship is achieved, the first workpiece is moved in a direction opposite to that of the final operation at the time of assembly, the approach position is set, and imaging is performed. Therefore, in the present embodiment, the approach position can be set as a positional relationship in which the held first workpiece can be appropriately assembled to the second workpiece by the robot. Also in the present embodiment, as in the first embodiment, it is not necessary to use the same object as a work workpiece and a teaching workpiece as long as various positional relationships can be recognized. In addition, it is not necessary to use the same mechanical device (robot arm) as a work robot arm and a teaching robot arm as long as various positional relationships can be recognized and a teaching content and a work content do not deviate from each other.

### Modified Example

The present invention is not limited to the embodiments described above, and many modifications can be made within the technical idea of the present invention. In addition, the effects described in the embodiments merely enumerate the most preferable effects that result from the present invention, and the effects of the present invention are not limited to those described in the embodiments.

In the above-described embodiments, a case where the feedback control unit 450 is a part of the function of the CPU 401 and the servo control unit 230 is implemented by a device different from the CPU 401 has been described, but the present technology is not limited thereto. The CPU 401 may be configured to implement some or all of the functions of the servo control unit 230 based on the program 430.

Furthermore, in the above-described embodiments, the current image feature amount Fc is displayed using the control device 400 and the display 600, but the present technology is not limited thereto. For example, an electronic device including a CPU and a display device such as a display panel may be separately used. The electronic device may be an information processing device such as a desktop personal computer (PC), a laptop PC, a tablet PC, or a smartphone. Furthermore, in a case where the input device 500 is a teaching pendant including a display device, the current image feature amount Fc, the current image IC, the target image feature amount F_{g}, and the like may be displayed on the display device.

Furthermore, in the above-described embodiments, a case where the robot arm 200 is a vertical articulated robot arm has been described, but the present technology is not limited thereto. The robot arm 200 may be various robot arms such as a horizontal articulated robot arm, a parallel link robot arm, and an orthogonal robot. That is, the present invention can be implemented in various articulated robots.

Furthermore, in the above-described embodiments, a case where the robot hand 300 is attached to the robot arm 200 has been described, but the present technology is not limited thereto. A holding mechanism capable of holding a holding object such as a workpiece may be attached to the robot arm 200 as the end effector. Examples of the holding mechanism include a mechanism for holding a workpiece by suction. In addition, a tool for machining a workpiece or the like may be attached to the robot arm 200 as the end effector.

Although the first workpiece W1 and the second workpiece W2 serving as objects are typically components, the present invention may be implemented in control of a robot that performs work of bringing a tool serving as the object into contact with a component. For example, the first workpiece may be a tool attached to the robot, and the second workpiece W2 may be a component. Alternatively, the first workpiece may be a tool held by the robot, and the second workpiece W2 may be a component. Alternatively, the present technology may be implemented as control when the robot performs work in which the robot grips a driver, a screw (first workpiece W1) is set in the driver by a magnet, and the screw is inserted into a screw hole of a component that is the second workpiece W2. As described above, the workpiece and the tool can be collectively referred to as the objects and can be referred to as a work object and a teaching object.

The control method, the control device, and the like according to the present invention can be applied to control of devices and facilities including various mechanical devices such as a production device including a movable portion, an industrial robot, a service robot, a medical robot, and a machine tool operated by numerical control by a computer.

The present invention can also be implemented by processing in which a program for implementing one or more functions of the embodiments is supplied to a system or a device via a network or a storage medium, and one or more processors in a computer of the system or the device read and execute the program. The present invention can also be implemented by a circuit (for example, an application specific integrated circuit (ASIC)) that implements one or more functions.

Furthermore, the contents of disclosure in the present specification include not only contents described in the present specification but also all of the items which are understandable from the present specification and the drawings accompanying the present specification. Moreover, the contents of disclosure in the present specification include a complementary set of concepts described in the present specification. Thus, if, in the present specification, there is a description indicating that, for example, “A is B”, even when a description indicating that “A is not B” is omitted, the present specification can be said to disclose a description indicating that “A is not B”. This is because, in a case where there is a description indicating that “A is B”, taking into consideration a case where “A is not B” is a premise.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-166526, filed Sep. 27, 2023, which is hereby incorporated by reference herein in its entirety.

What is claimed is:

1. A computer-implemented method for controlling a robot, the method comprising:
acquiring a current image showing a positional relationship between a first object held by the robot and a second object;
determining whether the first object and the second object are in a reference positional relationship based on the current image; and
controlling, in a case where a computer determines that the first object and the second object are in a reference positional relationship based on the current image, a position and a posture of the robot according to a trajectory of the robot set before the determining such that the first object and the second object have a target positional relationship.

2. The method according to claim 1,
wherein both the first object and the second object are included in the current image.

3. The method according to claim 1,
wherein the computer is configured to acquire an image feature amount according to a positional relationship between a portion of the first object and a portion of the second object from the current image, and to perform the determining based on the image feature amount.

4. The method according to claim 1,
wherein in the controlling of the position and the posture of the robot, the position and the posture of the robot are changed according to an operation of the robot instructed by a user after the acquiring the current image.

5. The method according to claim 1,
wherein the computer is configured to control, in a case where it is determined that the first object and the second object are in the reference positional relationship, the position and the posture of the robot by force control such that the first object and the second object have the target positional relationship.

6. The method according to claim 1,
wherein the computer is configured to control, in a case where it is determined that the first object and the second object are in the reference positional relationship, the position and the posture of the robot by position control such that the first object and the second object have the target positional relationship.

7. The method according to claim 1, wherein
the first object and the second object are separated from each other in the reference positional relationship, and
the first object and the second object are in contact with each other in the target positional relationship.

8. The method according to claim 2,
wherein an imaging unit configured to capture the current image is disposed so as to move according to a change in the position and the posture of the robot.

9. The method according to claim 1,
wherein the position and the posture of the robot are controlled by visual servoing such that the first object and the second object have the reference positional relationship.

10. The method according to claim 1
wherein the computer is configured to acquire a reference image showing that a first teaching object held by the robot and a second teaching object are in the reference positional relationship, and to determine whether the first object and the second object are in the reference positional relationship by using the current image and the reference image.

11. A robot control method comprising:
setting a position and a posture of a mechanical device such that a first teaching object held by the mechanical device and a second teaching object have a target positional relationship;
changing the position and the posture of the mechanical device holding the first teaching object such that the first teaching object and the second teaching object that are in the target positional relationship have a reference positional relationship;
acquiring a reference image showing that the first teaching object and the second teaching object are in the reference positional relationship; and
controlling, by a computer, in a case where the computer acquires a current image showing a positional relationship between a first object held by a robot and a second object and determines that the first object and the second object are in the reference positional relationship based on the reference image and the current image, a position and a posture of the robot holding the first object such that the first object and the second object have the target positional relationship.

12. The robot control method according to claim 11,
wherein in the controlling of the position and the posture of the robot, the position and the posture of the robot are changed according to an operation of the robot set before the determination or an operation of the robot instructed by a user after acquiring the current image.

13. The robot control method according to claim 11,
wherein in the controlling of the position and the posture of the robot, the position and the posture of the robot are changed based on transition of the position and the posture of the mechanical device in the changing.

14. The robot control method according to claim 11, wherein
the second teaching object is included in the reference image, and
the second object is included in the current image.

15. The robot control method according to claim 11,
wherein the computer is configured to control, in a case where it is determined that the first object and the second object are in the reference positional relationship, the position and the posture of the robot by force control such that the first object and the second object have the target positional relationship.

16. The robot control method according to claim 11,
wherein the computer is configured to control, in a case where it is determined that the first object and the second object are in the reference positional relationship, the position and the posture of the robot by position control such that the first object and the second object have the target positional relationship.

17. The robot control method according to claim 11, wherein
the first teaching object and the second teaching object are separated from each other in the reference positional relationship, and
the first teaching object and the second teaching object are in contact with each other in the target positional relationship.

18. The robot control method according to claim 11,
wherein an imaging unit configured to capture the current image is disposed so as to move according to a change in the position and the posture of the robot.

19. The robot control method according to claim 11,
wherein the position and the posture of the robot are controlled by visual servoing such that the first object and the second object have the reference positional relationship.

20. The robot control method according to claim 11,
wherein the mechanical device is the robot.

21. A system configured to execute the method according to claim 1, the system comprising the computer.

22. The system according to claim 21, further comprising:
the robot; and
a control unit configured to control the robot.

23. The system according to claim 21, wherein
the robot is an articulated robot, and
a force sensing sensor is provided in at least one joint of the articulated robot.

24. The system according to claim 21,
further comprising an imaging unit configured to capture the current image.

25. An article manufacturing method comprising:
controlling the robot by the method according to claim 1 to assemble the first object to the second object.

26. A recording medium storing a program for causing the computer to execute the method according to claim 1.
